(19) United States
(12) Patent Application Publication
(10) Pub. No.: US 2026/0202976 A1
(43) Pub. Date: Jul. 16, 2026

(54) UPDATING CONFIGURATIONS OF DEPLOYED CLOUD-BASED STORAGE SYSTEMS

(71) Applicant: Dell Products L.P., Round Rock, TX (US)

(72) Inventors: Michal Sara Davidson, Beit Shemesh (IL); Shoham Levy, Pardes Hana-Karur (IL)

(21) Appl. No.: 19/025,192

(22) Filed: Jan. 16, 2025

(51) Int. Cl. G06F 3/06

(52) U.S. Cl. CPC G06F 3/0629; G06F 3/0607; G06F 3/0653; G06F 3/067

(57) ABSTRACT

Techniques are provided for updating configurations of deployed cloud-based storage systems. One method comprises obtaining storage system metrics and infrastructure node utilization metrics for a storage system at least partially deployed on a cloud; obtaining available infrastructure node type options on the cloud; determining possible configurations of the storage system. using the available infrastructure node type options; determining an infrastructure operating parameter of the possible configurations of the storage system for at least a designated time period; determining a migration parameter for migrating data from a first configuration of the storage system to each of the possible configurations of the storage system; selecting a given one of the possible configurations of the storage system based on the respective infrastructure parameter and the respective migration parameter; and initiating an update of the configuration of the storage system using the selected possible configuration.

### BACKGROUND

The amount of data that must be stored and managed, for example, in datacenters and other cloud-based storage systems, continues to increase. To meet such data storage demands, such cloud-based storage systems increasingly use a software-defined storage platform that provides significant flexibility, enhanced storage performance and scalability for the data storage environment. At least portions of such software-defined storage platforms are increasingly deployed in a virtual environment.

### SUMMARY

Illustrative embodiments of the disclosure provide techniques for updating configurations of deployed cloud-based storage systems. An exemplary method comprises obtaining one or more storage system metrics and one or more infrastructure node utilization metrics for a storage system at least partially deployed on at least one cloud; obtaining available infrastructure node type options on the at least one cloud; determining a plurality of possible configurations of the storage system, using the available infrastructure node type options, based at least in part on an evaluation of at least one of the one or more storage system metrics and the one or more infrastructure node utilization metrics; determining an infrastructure operating parameter of each of at least two of the possible configurations of the storage system for at least a designated time period; determining a migration parameter for migrating data from a first configuration of the storage system to each of the at least two possible configurations of the storage system; selecting a given one of the at least two possible configurations of the storage system based at least in part on the respective infrastructure parameter and the respective migration parameter; and initiating an update of the configuration of the storage system using the selected possible configuration.

Illustrative embodiments can provide significant advantages relative to conventional techniques. For example, problems associated with conventional techniques for reconfiguring a cloud-based storage system are overcome in one or more embodiments by identifying available infrastructure node options and selecting a given storage system configuration based at least in part on an evaluation of the migration of data from a current storage system configuration to an updated storage system configuration.

Other illustrative embodiments include, without limitation, apparatus, systems, methods and computer program products comprising processor-readable storage media.

### BRIEF DESCRIPTION OF THE DRAWINGS

FIG. 1 illustrates a network computing environment that can be configured for updating configurations of deployed cloud-based storage systems in accordance with an illustrative embodiment;

FIG. 2 illustrates a deployment of a storage system using multiple availability zones in an illustrative embodiment;

FIG. 3 illustrates a cloud configuration platform in accordance with an illustrative embodiment;

FIG. 4 illustrates exemplary pseudocode for an infrastructure recommendation process in accordance with an illustrative embodiment;

FIG. 5 illustrates exemplary pseudocode for an infrastructure tuning process in accordance with an illustrative embodiment;

FIG. 6 illustrates a storage system deployment having multiple availability zones prior to a configuration update by the cloud configuration platform of FIG. 3 in an illustrative embodiment;

FIG. 7 illustrates the storage system deployment of FIG. 6 following a configuration update by the cloud configuration platform of FIG. 3 in an illustrative embodiment;

FIG. 8 illustrates exemplary pseudocode for a cloud configuration process in accordance with an illustrative embodiment;

FIG. 9 illustrates exemplary pseudocode for an infrastructure recommendation process in accordance with an illustrative embodiment;

FIG. 10 illustrates exemplary pseudocode for an infrastructure tuning process in accordance with an illustrative embodiment;

FIG. 11 is a flow diagram illustrating an exemplary implementation of a method for updating configurations of deployed cloud-based storage systems in accordance with an illustrative embodiment;

FIG. 12 illustrates an exemplary processing platform that may be used to implement at least a portion of one or more embodiments of the disclosure comprising a cloud infrastructure; and

FIG. 13 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for updating configurations of deployed cloud-based storage systems.

In one or more embodiments, techniques are provided for updating configurations of deployed cloud-based storage systems. As noted above, software-defined storage platforms are increasingly deployed in a virtual environment, such as on a public cloud. Deploying storage systems on the cloud offers many advantages including scalability, elasticity, operating expense cost models and locality to applications deployed on the cloud. Storage systems deployed on the cloud, however, often exhibit significant public cloud infrastructure costs, and are impacted by frequent changes to cloud offerings, leading to challenges in how to reduce (e.g., optimize) the infrastructure costs for such for storage systems.

In some embodiments, cloud-based storage system configuration techniques are provided that, post-deployment, monitor a usage of the storage systems, as well as changing public cloud infrastructure offerings and costs. The cloud-based storage system configuration techniques recommend real-time adjustments of at least portions of the infrastructure in order to meet the requirements of the storage system, without over-spending on costly and unnecessary infrastructure.

For example, the disclosed cloud configuration platform, in at least some embodiments, can recommend a scaling up or down of instance types to achieve better latency, or higher capacity per node, a scaling in or out of the number of instances to increase capacity and/or bandwidth, an optimization of instance type (including introducing new instance types that were not available at deployment time) to satisfy latency, throughput and/or capacity goals and/or a creation of storage tiers (e.g., in the form of protection domains of uniform node types) to meet specific performance goals. In at least some embodiments, an instance comprises a virtual machine or a container executing in the public cloud. An instance type may comprise a type of virtual machine or container, as defined by a cloud service provider, to have a specific processor; amount, size, and type of storage drives; amount of virtual CPUs, GPUs or other processing units, for example; size of RAM; network throughput and latency. An instance family may comprise a type of instance, typically with multiple instance types, all with the same processor, and drive type (with a differing amount of drives, size of drives, number of vCPUs or GPUs, size of RAM, and networking constraints).

The disclosed cloud configuration platform can balance cost savings and performance improvements to dynamically configure a storage array. The recommended configuration of a deployed cloud-based storage system can address the dynamic storage requirements using appropriate cloud infrastructure, as a post-deployment operation, taking into account changes to varying instance type options and pricing in the public cloud, without significantly impacting storage operations or requiring a costly, risky, and disruptive migration procedure.

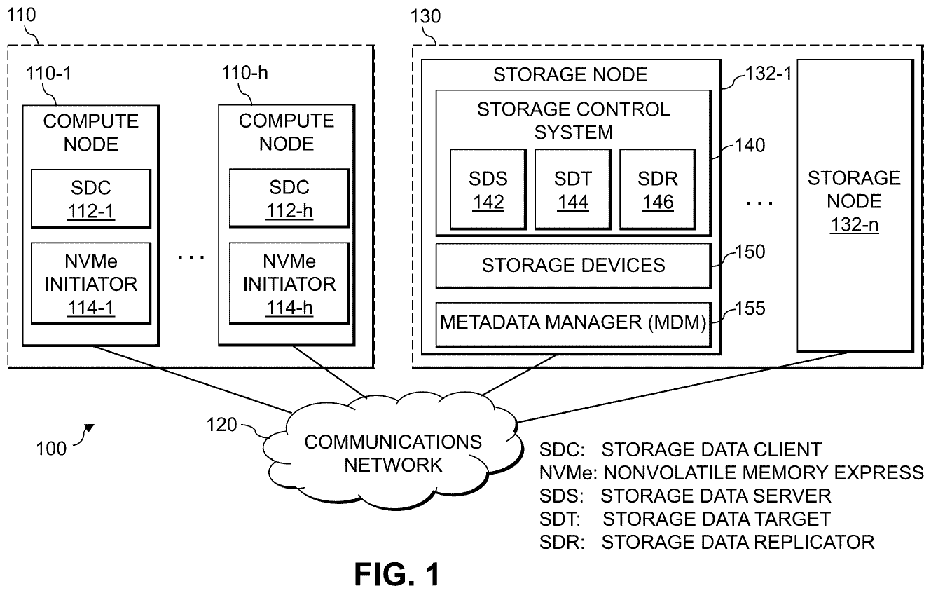

FIG. 1 schematically illustrates a computing environment 100 that can be configured for updating configurations of deployed cloud-based storage systems, according to an exemplary embodiment of the disclosure. In particular, FIG. 1 schematically illustrates one or more compute nodes 110-1 . . . 110-h (collectively, compute nodes 110), a communications network 120 and a data storage system 130 comprising a plurality of storage nodes 132-1 . . . 132-n (collectively, storage nodes 132).

In some embodiments, each compute node 110-1 . . . 110-h respectively comprises a storage data client (SDC) 112-1 . . . 112-h and a non-volatile memory express (NVMe) initiator 114-1 . . . 114-h (or NVMe initiator 114), the functions of which will be explained below.

As further shown in FIG. 1, the storage node 132-1 comprises a storage control system 140, storage devices 150 and a metadata manager (MDM) 155. A storage device target, for example, of a given storage node 132 can be a backend target configured to manage storage devices 150 and to coordinate a processing of I/O operations on one or more of the storage devices 150.

In some embodiments, the storage control system 140 is a software-defined storage control system that comprises a storage data server (SDS) 142, a storage data target (SDT) 144 and a storage data replicator (SDR) 146, the functions of which will be explained below. In some embodiments, the other storage nodes (e.g., storage node 132-n) have the same or similar configuration as the storage node 132-1 shown in FIG. 1. The SDT 144 can be a front-end target that is a software component configured to provide support for one or more communication protocols.

The compute nodes 110 may comprise physical server nodes and/or virtual server nodes that host and execute applications that are configured to process data and execute tasks/workloads and perform computational work, either individually, or in a distributed manner, to thereby provide compute services to one or more users (the term “user” herein is intended to be broadly construed so as to encompass numerous arrangements of human, hardware, software or firmware entities, as well as combinations of such entities, including clients and/or application programming interfaces employed by the user). In some embodiments, the compute nodes 110 comprise application servers, database servers, etc. The compute nodes 110 can include virtual nodes such as virtual machines and container systems. In some embodiments, the compute nodes 110 comprise a cluster of computing nodes of an enterprise computing system, a cloud-based computing system, or other types of computing systems or information processing systems comprising multiple computing nodes associated with respective users. The compute nodes 110 issue data access requests to the data storage system 130, wherein the data access requests include (i) write requests to store data in one or more of the storage nodes 132 and (ii) read requests to access data that is stored in one or more of the storage nodes 132.

The communications network 120 is configured to enable communication between the compute nodes 110 and the storage nodes 132, as well as peer-to-peer communications between the storage nodes 132. In this regard, while the communications network 120 is generically depicted in FIG. 1, it is to be understood that the communications network 120 may comprise any known communication network such as, a global computer network (e.g., the Internet), a wide area network (WAN), a local area network (LAN), an intranet, a satellite network, a telephone or cable network, a cellular network, a wireless network such as Wi-Fi or WiMAX, a storage fabric (e.g., IP-based or Fiber Channel storage fabric), or various portions or combinations of these and other types of networks. In this regard, the term “network” as used herein is therefore intended to be broadly construed so as to encompass a wide variety of different network arrangements, including combinations of multiple networks possibly of different types, that enable communication using, e.g., Transfer Control Protocol/Internet Protocol (TCP/IP) or other communication protocols such as Fibre Channel (FC), FC over Ethernet (FCoE), RDMA over Converged Ethernet (RoCE), Internet Small Computer System Interface (iSCSI), Peripheral Component Interconnect express (PCIe), InfiniBand, Gigabit Ethernet, etc., to implement I/O channels and support storage network connectivity. Numerous alternative networking arrangements are possible in a given embodiment, as will be appreciated by those skilled in the art.

In some embodiments, each storage node 132 comprises a server node (e.g., storage-only node) that is implemented on, e.g., a physical server machine or storage appliance comprising hardware processors, system memory, and other hardware resources that execute software and firmware to implement the functionality of the storage node 132 and the associated storage control system 140. In some embodiments, each storage node 132 comprises a plurality of control processors that execute a lightweight operating system (e.g., a customized lightweight Linux kernel) and functional software (e.g., software-defined storage software) to implement functions of the storage control system 140, as discussed in further detail below.

The storage devices 150 of a given storage node 132 can be internal storage devices and/or direct-attached storage devices, and may comprise one or more of various types of storage devices such as hard-disk drives (HDDs), solid-state drives (SSDs), flash memory cards (e.g., PCIe cards), or other types of non-volatile memory (NVM) devices including, but not limited to, non-volatile random-access memory (NVRAM), phase-change RAM (PC-RAM), magnetic RAM (MRAM), and other types of storage media, etc. In some embodiments, the storage devices 150 comprise flash memory devices such as NAND flash memory, NOR flash memory, etc. The NAND flash memory can include single-level cell (SLC) devices, multi-level cell (MLC) devices, triple-level cell (TLC) devices, or quad-level cell (QLC) devices. These and various combinations of multiple different types of storage devices 150 may be implemented on each storage node 132. In this regard, the term “storage device” as used herein should be broadly construed to encompass all types of persistent storage media including hybrid drives. On a given storage node 132, the storage control system 140 is configured to communicate with the storage devices 150 through any suitable host interface, e.g., a host bus adapter, using suitable protocols such as Advanced Technology Attachment (ATA), serial ATA (SATA), external SATA (eSATA), parallel ATA (PATA), non-volatile memory express (NVMe), small computer system interface (SCSI), serial attached SCSI (SAS), peripheral component interconnect express (PCIe), etc.

The data storage system 130 may comprise any type of data storage system, or a combination of data storage systems, including, but not limited to, a storage area network (SAN) system, a dynamic scale-out data storage system, or other types of distributed data storage systems comprising software-defined storage, clustered or distributed virtual and/or physical infrastructure. The term “data storage system” as used herein should be broadly construed and not viewed as being limited to storage systems of any particular type or types. In some embodiments, the data storage system 130 comprises a dynamic scale-out storage system that allows additional storage nodes to be added (or removed) to the cluster to scale the performance and storage capacity of the data storage system 130. It is to be noted that each storage node 132 and associated storage devices 150 is an example of what is more generally referred to herein as a “storage system” or a “storage array.”

In some embodiments, the data storage system 130 comprises a dynamic scale-out software-defined storage system that is configured to implement a high-capacity block-level SAN storage system (e.g., virtual SAN system) that consolidates the capacity of the storage devices 150 (e.g., HDDs, SSDs, NVMe flash storage, flash PCIe cards etc.) of the storage nodes 132 into shared block storage that is logically partitioned into logical storage volumes identified by, e.g., logical unit numbers (LUNs). In an exemplary embodiment of a scale-out software-defined SAN storage system, the storage control systems 140 comprise software components of a software-defined storage system, that are executed on the storage nodes 132 to implement a software-defined storage environment in which the storage nodes 132 form a loosely coupled storage server cluster and collectively communicate and operate to create a server-based SAN system (e.g., virtual SAN) to provide host access to a virtual pool of block storage using the combined storage capacity (e.g., storage devices 150) of the storage nodes 132.

In some embodiments, the SDCs 112, the MDMs 155, the SDSs 142, the SDTs 144, and the SDRs 146, for example, of the storage nodes 132 comprise software components of a software-defined storage platform, wherein the software components are installed on physical server machines (or server nodes) such as application servers, storage servers, control servers, etc. In some embodiments, virtual machines (e.g., Linux-based virtual machines) are utilized to host the software components of the software-defined storage platform. The software components collectively implement various functions for deploying and managing a software-defined, scale-out server SAN architecture that can grow from a few servers to thousands of severs.

For example, the SDS 142 comprises a service that is configured to manage the storage capacity (e.g., storage devices 150) of a single server (e.g., storage node 132) and provide back-end access to the storage devices of the server. In other words, the SDS 142 is installed on each server that contributes some or all of the capacity of its local storage devices to the scale-out data storage system. More specifically, in the scale-out software-defined storage environment, the SDSs 142 of the storage control systems 140 are configured to create and manage storage pools (e.g., virtual pools of block storage) by aggregating storage capacity of the respective storage devices 150 and dividing each storage pool into one or more volumes, wherein the volumes are exposed to the SDCs 112 of the compute nodes 110 as virtual block devices. For example, a virtual block device can correspond to a volume of a storage pool. Each virtual block device comprises any number of actual physical storage devices, wherein each virtual block device is preferably homogenous in terms of the type of storage devices that make up the block device (e.g., a block device can include only HDD devices or SSD devices, etc.). In this regard, each instance of the SDS 142 that runs on a respective one of the storage nodes 132 contributes some or all of its local storage space to an aggregated virtual pool of block storage with varying performance tiers (e.g., HDD, SSD, etc.) within a virtual SAN.

In some embodiments, each SDC 112 that executes on a given compute node 110 comprises a lightweight block device driver that is deployed to expose shared block volumes to the compute nodes 110. An SDC 112 may expose one or more designated test volumes, discussed further below. In particular, each SDC 112 is configured to expose the storage volumes as block devices to the applications located on the same server (e.g., application server) on which the SDC 112 is installed. In other words, as shown in FIG. 1, the SDCs 112 run on the same server machines as the compute nodes 110 that require access to the block devices exposed and managed by the SDSs 142 of the storage nodes 132. The SDC 112 of a given compute node 110 exposes block devices representing the virtual storage volumes that are currently mapped to the given compute node 110. In particular, the SDC 112 for a given compute node 110 serves as a block driver for the compute node 110, wherein the SDC 112 intercepts I/O requests, and utilizes the intercepted I/O request to access the block storage that is managed by the SDSs 142. The SDCs 112 are installed in the operating system or hypervisor hosting the application layer and provide the operating system or hypervisor (that runs the SDC 112) access to the logical block devices (e.g., volumes). The SDCs 112 have knowledge of which SDSs 142 hold its block data, so multipathing can be accomplished natively through the SDCs 112, where the communications network 120 is configured to provide an any-to-any connection between the compute nodes 110 and the storage nodes 132. More specifically, each SDC 112 connects to every SDS 142, which eliminates the need for multipath software, in at least some embodiments.

In some embodiments, the MDMs 155 implement a management layer on one or more of the storage nodes 132 that manages and configures the software-defined storage system in the computing environment 100. The MDMs 155 are services that function as a monitoring and configuration agent of the storage environment. More specifically, in some embodiments, the management layer is configured to supervise the operations of the storage cluster and manage storage cluster configurations. For example, the MDMs 155 (or an MDM cluster) manage the storage system by aggregating the entire storage exposed to the MDM cluster by the SDSs 142 to generate a virtual storage layer (e.g., virtual SAN storage layer), wherein logical volumes can be defined over storage pools and exposed to host applications as a local storage device using the SDCs 112.

Further, the MDMs 155 are configured to manage various types of metadata associated with the software-defined storage system. For example, such metadata includes a mapping of the SDCs 112 to the SDSs 142 of the storage nodes 132, wherein such mapping information is provided to the SDCs 112 and the SDSs 142 to allow such components to control I/O data path operations (e.g., allow the SDCs 112 to communicate with target SDSs 142 to access data in logical volumes that are mapped to the SDCs 112). In addition, the MDMs 155 collect connectivity status updates from the SDCs 112 to monitor all connections between SDCs 112 and the SDSs 142 to determine the current system state, and post events whenever a given SDC 112 connects to or disconnects from a specific IP address of a given SDS 142.

In addition, the MDMs 155 may be configured to manage various management operations such as data migration, rebuilds, and other system-related functions. In this regard, the MDMs 155 generate and manage various types of metadata that are required to perform various management operations in the storage environment such as, e.g., performing data migration operations, performing rebalancing operations, managing configuration changes, managing the SDCs 112 and the SDSs 142, maintaining and updating device mappings, maintaining management metadata for controlling data protection operations such as snapshots, replication, RAID configurations, etc., managing system capacity including storage device allocations and/or release of capacity, performing operations for recovery from errors and failures, and system rebuild tasks, etc. The MDMs 155 communicate with the SDCs 112 to provide notification of changes in data layout, and communicate with the SDSs 142 to coordinate rebalancing operations. In some embodiments, the MDMs 155 are configured to implement a distributed cluster management system.

In some embodiments, the software-defined storage system utilizes various logical entities that link the physical layer to the virtual storage layer, wherein such logical entities include protection domains, fault sets, and storage pools. In some embodiments, a protection domain is a logical entity that comprises a group of SDSs 142 that provide backup for each other. Each SDS 142 belongs to only one protection domain such that each protection domain comprises a unique set of SDSs 142. In some embodiments, each protection domain can have up to a maximum number of SDS nodes (e.g., 128 SDS nodes). The use of protection domains enables optimal performance, reduction of mean time between failure (MTF) issues, and the ability to sustain multiple failures in different protection domains.

Further, in some embodiments, a fault set is a logical entity that defines a logical group of SDS nodes (within a protection domain) that are more inclined to fail together, e.g., a group of SDS nodes within a given protection domain that are all powered in a same rack. By grouping SDS nodes into a given fault set, the system is configured to mirror the data for all storage devices in the given fault set, wherein mirroring is performed on SDS nodes that are outside the given fault set. A fault unit can be either a fault set or an SDS node that is not associated with a fault set. In some embodiments, user data is maintained in a RAID-1 mesh mirrored layout, where each piece of data is stored on two different fault units. The copies are distributed over the storage devices according to an algorithm that ensures uniform load of each fault unit in terms of capacity and expected network load.

Moreover, in some embodiments, a storage pool is a logical entity that defines a set of physical storage devices in a protection domain, wherein each storage device belongs to only one storage pool. When a volume is configured over the virtualization storage layer, in some embodiments, the volume is distributed over all devices residing in the same storage pool. Each storage pool comprises a homogeneous set of storage devices (e.g., HDD storage pool, or SSD storage pool) to enable storage tiering. In some embodiments, each volume block has two copies located on two different fault units (e.g., two different SDS nodes), that allows the system to maintain data availability following a single-point failure.

The SDR 146 is a software component that is configured to implement a data replication system, e.g., journal-based asynchronous replication. In some embodiments, asynchronous replication is performed between two peer data storage systems, which are connected via a WAN. In general, in some embodiments, asynchronous replication involves writing data to a source (primary) volume in a first data storage system and acknowledging completion of an I/O write operation to a host application before the data is replicated to a target (replica) volume in a second (remote) data storage system (e.g., the source (primary) volume and the target (replica) volume do not share hardware elements in at least some embodiments). With asynchronous replication, the I/O write operations at a source storage node are logged in a replication journal by a source SDR 146 on the source storage node, and the replication journal is periodically transmitted at scheduled times to a target storage node, wherein a target SDR 146 on the target storage node processes the received replication journal to replicate data to a target (replica) volume. The data replication system can be utilized for various purposes including, but not limited to, recovering from a physical or logical disaster, migrating data, testing data at a remote site, or offloading a data backup operation.

More specifically, in the exemplary embodiment of FIG. 1, the SDR 146 is responsible for processing all I/O requests associated with replicated volumes. In the source system, for replicated volumes, the SDCs 112 communicate with the SDR 146. For non-replicated volumes, the SDCs 112 communicate directly with the SDSs 142. At a source storage node, application I/O requests associated with a replicated volume are sent in some embodiments by an SDC 112 to a source SDR 146. The source SDR 146 will write the required journal data to a replication journal volume, and then send a duplicate of the replication I/O write request and associated user data to the SDS 142 wherein the SDS 142 performs write operations to write the received I/O user data in a primary volume. The journal data is then transmitted to a target SDR 146 on a target storage node, which processes the received replication journal to replicate data to the target (replica) volume. In some embodiments, a minimum of two SDRs are deployed on the source and target storage nodes to maintain high availability. If one SDR fails, the management layer (e.g., one or more MDM nodes) directs the SDCs to send the I/O requests for replicated volumes to an available SDR 146.

The SDT 144 can be a front-end target that is a software component configured to provide support for, for example, NVMe-oF, in particular, NVMe over TCP (NVMe/TCP) that enables NVMe-oF across a standard Ethernet network. In some embodiments, the SDT 144 is configured in the storage layer to handle the I/O requests of the NVMe initiators 114 to provide support for the NVMe/TCP storage protocol for front end connectivity, and thus, allow the use of NVMe/TCP hosts in addition to the SDCs 112. In some embodiments, the SDT 144 is an NVMe target that is configured to translate control and I/O data path packets to the NVMe standard protocol, wherein each NVMe initiator 114 is serviced by multiple SDTs 144 depending on the supported number of paths in the NVMe multipathing driver. In essence, I/O requests are sent from a host NVMe initiator 114 (which is installed in the host operating system or hypervisor) to the SDT 144, and the SDT 144 communicates with a target SDS 142 to direct the I/O request to the target SDS 142.

A distributed storage system may employ user data storage volumes for storing user data, and metadata storage volumes for storing the metadata corresponding to the user data. The metadata associated with a given SDS may be managed by one or more metadata units. The ownership of the user data storage capacity may be spread among multiple metadata units. The number of metadata units on a given SDS may vary. The different metadata units on an SDS may each have a different number of metadata pages at a given time. In order to provide a scalable system, one or more aspects of the disclosure recognize that the metadata storage volumes should start at a designated size and be expandable to support additional metadata pages.

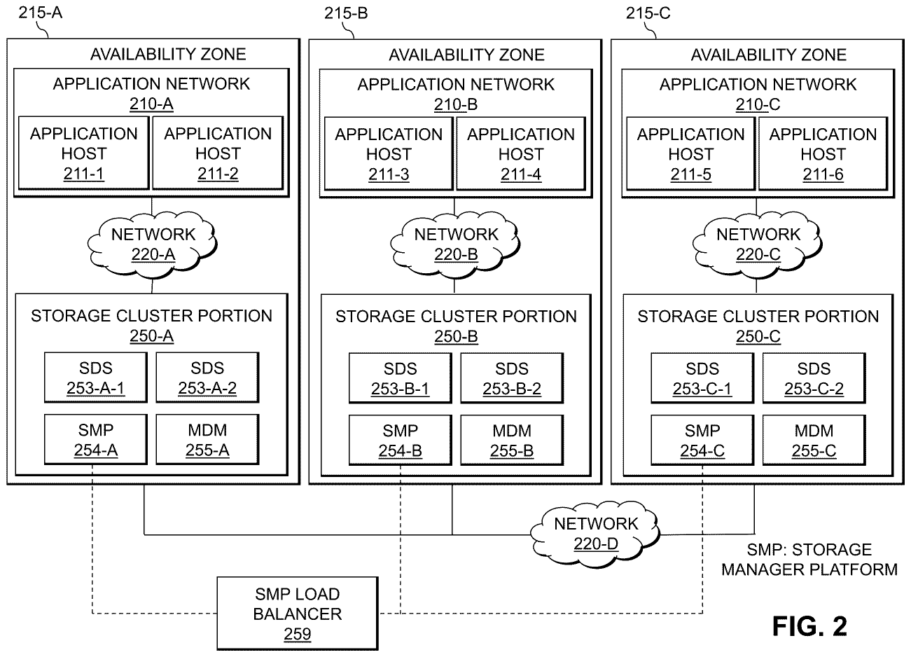

FIG. 2 illustrates a storage system (e.g., a software-defined storage system) in accordance with an illustrative embodiment. In particular, FIG. 2 illustrates a computing environment comprising computing and storage resources that are separated into a plurality of availability zones 215-A, 215-B and 215-C (e.g., within a given region of a public cloud vendor).

In the example of FIG. 2, hosts (e.g., applications) are deployed in application networks 210-A, 210-B and 210-C (collectively, application networks 210) and a storage system is deployed in a storage cluster comprised of storage cluster portions 250-A, 250-B and 250-C (collectively, storage cluster portions 250). The application networks 210 and the storage cluster portions 250 may be interconnected, for example, using respective networks 220-A, 220-B and 220-C (e.g., as part of a virtual private cloud (VPC)). The application network 210-A and storage cluster portion 250-A are part of a first availability zone 215-A, application network 210-B and storage cluster portion 250-B are part of a second availability zone 215-B, and application network 210-C and storage cluster portion 250-C are part of a third availability zone 215-C. Although not shown for clarity of illustration, a private cloud deployment may include one or more additional availability zones each having an application network and a storage cluster portion configured in a manner similar to that of the availability zones 215-A, 215-B and 215-C (collectively, availability zones 215). The different availability zones 215-A, 215-B and 215-C may be interconnected, for example, using one or more networks 220-D.

The application network 210-A includes a first set of application hosts 211-1 and 211-2, the application network 210-B includes a second set of application hosts 211-3 and 211-4, and the application network 210-C includes a third set of application hosts 211-5 and 211-6. The application hosts 211-1 through 211-6 are collectively referred to as application hosts 211.

The storage cluster portion 250-A includes SDSs 253-A-1 and 253-A-2 (collectively, SDSs 253-A), a storage manager platform (SMP) 254-A (e.g., which may be implemented as a cluster controller), and an MDM 255-A. The SDSs 253-A aggregate storage media (e.g., local storage) as one or more unified storage pools on which logical volumes are created, and are examples of what are more generally referred to herein as “storage nodes.” The SMP 254-A provides functionality for load balancing among the storage nodes through communications with an SMP load balancer 259. The MDM 255-A provides functionality for management of the storage system. The storage cluster portions 250-B and 250-C may be implemented in a similar manner as the storage cluster portion 250-A.

As discussed hereinafter, updated deployment instructions can be applied to a cloud-based storage system using the SMP load balancer 259.

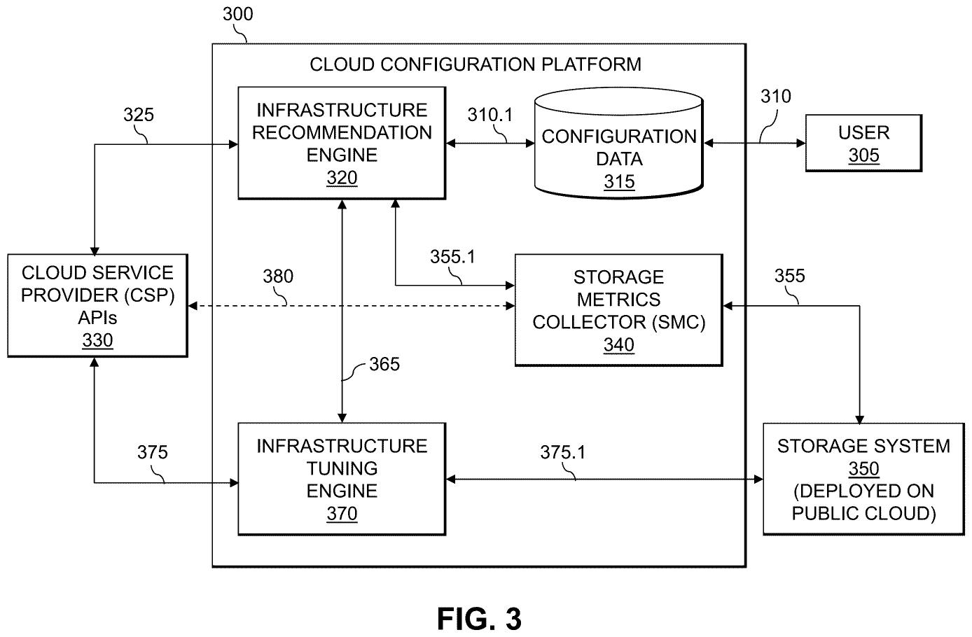

FIG. 3 illustrates a cloud configuration platform 300 in accordance with an illustrative embodiment. In the example of FIG. 3, the cloud configuration platform 300 comprises a database storing configuration data 315, an infrastructure recommendation engine 320, a storage metrics collector (SMC) 340 and an infrastructure tuning engine 370. Generally, the cloud configuration platform 300, in some embodiments, comprises logic for analyzing storage metrics, recommending cloud infrastructure improvements (e.g., optimizations), and performing a switch out of current storage nodes and storage drives for recommended storage nodes and storage drives (e.g., in real time).

A user 305 can provide configuration instructions 310 that define at least portions of the configuration data 315 that configures the cloud configuration platform 300 and storage system constraints. The user 305 may specify one or more thresholds for when to implement configuration changes (e.g., storage and/or performance utilization thresholds), and optionally one or more additional customer-configured constraints. For example, the customer-configured constraints may comprise, in some embodiments, a choice between high resiliency or medium resiliency (where high resiliency implies only using EBS (elastic block storage) and medium resiliency allows usage of ephemeral storage, such as direct attached storage that may be bound to a specific instance and may be deleted with that instance); cross-availability zone resiliency (e.g., always deploy across multiple availability zones); a minimum IOPs per cluster or node (e.g., overriding measured performance requirements); and/or a minimum throughput per cluster or node (e.g., overriding measured performance requirements).

In addition, as noted above, the user 305 can provide configuration instructions 310 that define at least portions of the cloud configuration platform 300. For example, the customer can configure one or more configuration thresholds for the cloud configuration platform 300, such as a frequency of optimization refreshes, and maintenance-windows; a required lower threshold for storage capacity utilization; a highest threshold for storage capacity utilization of a node; a lowest allowed utilization of memory and/or CPU per node; and/or a highest allowed utilization of memory and/or CPU per node.

In at least some embodiments, the infrastructure recommendation engine 320 can poll one or more cloud service provider (CSP) APIs 330 (e.g., using an SDK (Software Development Kit)) to obtain infrastructure information 325. In addition, the infrastructure recommendation engine 320 monitors a storage system 350 deployed on the public cloud using the SMC 340 for storage system metrics 355.1 (e.g., capacity and IOPs (input/output operations per second)). The SMC 340 obtains the storage system metrics 355.1 from the storage system 350 using communications 355.

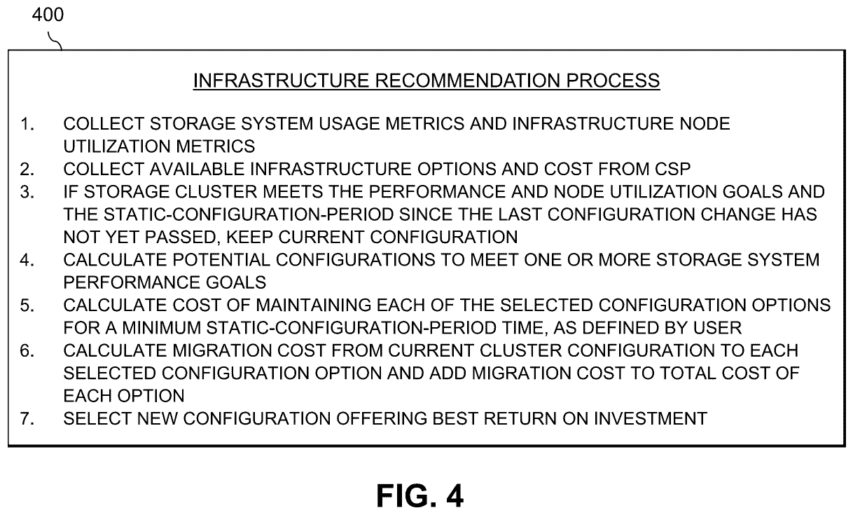

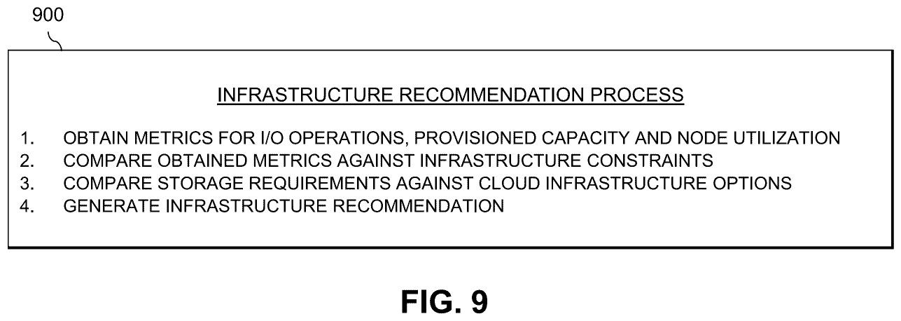

The infrastructure recommendation engine 320 may provide one or more recommended topologies 365 for the storage system 350 to the infrastructure tuning engine 370. The infrastructure recommendation engine 320 may generate the one or more recommended topologies 365 for the storage system 350, for example, using at least portions 310.1 of the configuration data 315, as discussed further below in conjunction with FIGS. 4 and 9, for example.

The SMC 340 is responsible in at least some embodiments for performing analytics of current storage capacity utilization and performance (e.g., pulling data from storage system read/write metrics). The storage consumption metrics can be collected natively within the storage product, by an external third-party tool or by a cloud-native CSP service (e.g. CloudWatch). In addition, the SMC 340 may be performing analytics of the utilization level of the storage system node resources, such as memory, CPU and/or network utilization. The SMC 340 may also use the CSP APIs 330 to obtain cloud metrics 380, such as infrastructure node utilization metrics and cost information.

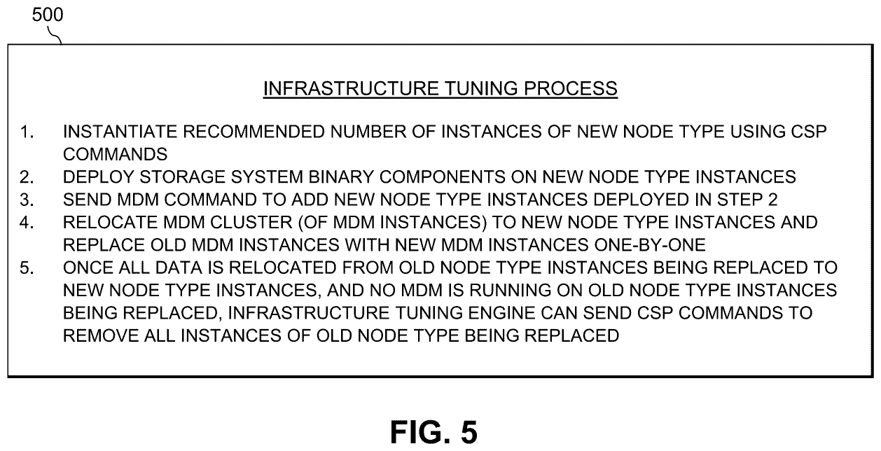

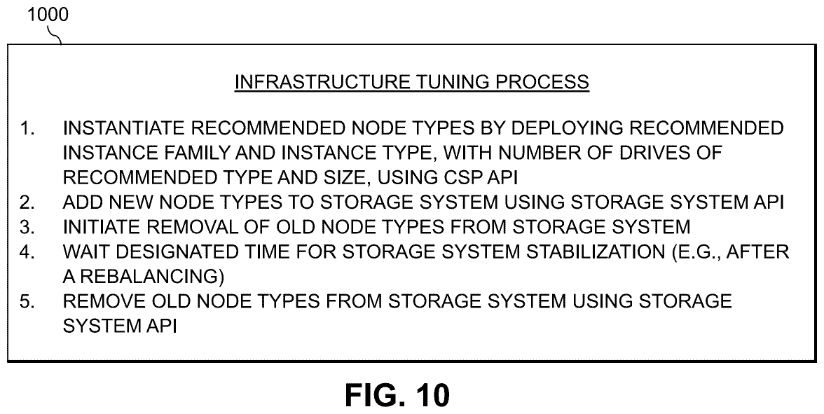

If a given recommended topology for the storage system 350 is adopted, the infrastructure tuning engine 370 implements the adopted infrastructure changes by making one or more calls 375 using one or more of the CSP APIs 330 (e.g., to allocate and/or release (e.g., spin up and/or tear down) specified infrastructure elements) and also by one or more calls 375.1 to the storage system 350 (e.g., to add, remove and/or migrate one or more storage nodes). The infrastructure tuning engine 370 is discussed further below in conjunction with FIGS. 5 and 10, for example.

In at least some embodiments, the communications with the CSP APIs are CSP specific, since CSP-specific details may be needed, such as instance types, and corresponding instance costs.

The cloud configuration platform 300 may be implemented, for example, within the storage system 350 (e.g., on one or more storage system nodes) and/or outside the storage system 350 (e.g., on separate instances or as a stateless function (e.g., a lambda function).

FIG. 4 illustrates exemplary pseudocode for an infrastructure recommendation process 400 in accordance with an illustrative embodiment. In the example of FIG. 4, the infrastructure recommendation process 400 initially collects storage system usage metrics using the SMC 340 and infrastructure node utilization metrics using the CSP APIs 330, as well as available infrastructure options and cost from the CSP APIs 330. If the storage cluster meets the performance goals and node utilization goals specified in the configuration data 315, and the static-configuration-period since the last configuration change has not yet passed, the infrastructure recommendation process 400 will keep current the configuration. A periodic evaluation interval (e.g., once a week) may be specified for the infrastructure recommendation engine 320 to wake up and reevaluate, for example, a return on investment (ROI) of the cluster, and the static-configuration-period (e.g., six months) may be a minimal time period for a specific storage array infrastructure configuration to stay static (e.g., and to not change) unless the storage cluster fails to meet minimum performance and/or utilization requirements.

The infrastructure recommendation process 400 may otherwise calculate (i) one or more potential configurations to meet one or more storage system performance goals; (ii) a cost of maintaining each of the selected configuration options for a minimum static-configuration-period time, as defined by user; and (iii) a migration cost from a current cluster configuration to each selected configuration option (adding the migration cost to the total infrastructure cost of each option). The calculation of the one or more potential configurations may include the current configuration, for example, if the static-configuration-period has passed and the current configuration is still relevant. The infrastructure recommendation engine 320 may select 5-10 of the potential configurations, for example, based on one or more specified criteria. A prediction algorithm (e.g., a linear or machine learning driven prediction algorithm) may be used to anticipate capacity growth for the period of the static-configuration-period and the selected potential configurations that meet the future capacity requirements may be selected. The calculation of the migration cost for the current configuration will be zero. The migration costs may include, for example, costs associated with extensive data copying, additional network utilization, and the costs for time periods where old and new infrastructure nodes are running side-by-side.

The infrastructure recommendation process 400 selects a new configuration from the identified potential configurations that offers the best ROI, for example.

FIG. 5 illustrates exemplary pseudocode for an infrastructure tuning process 500 in accordance with an illustrative embodiment. In the example of FIG. 5, the infrastructure tuning process 500 instantiates a recommended number of instances of a new node type using one or more CSP commands and deploys storage system binary components on the new SDS node type instances. In addition, one or more MDM commands are sent to add the new node type instances that were deployed in step 2.

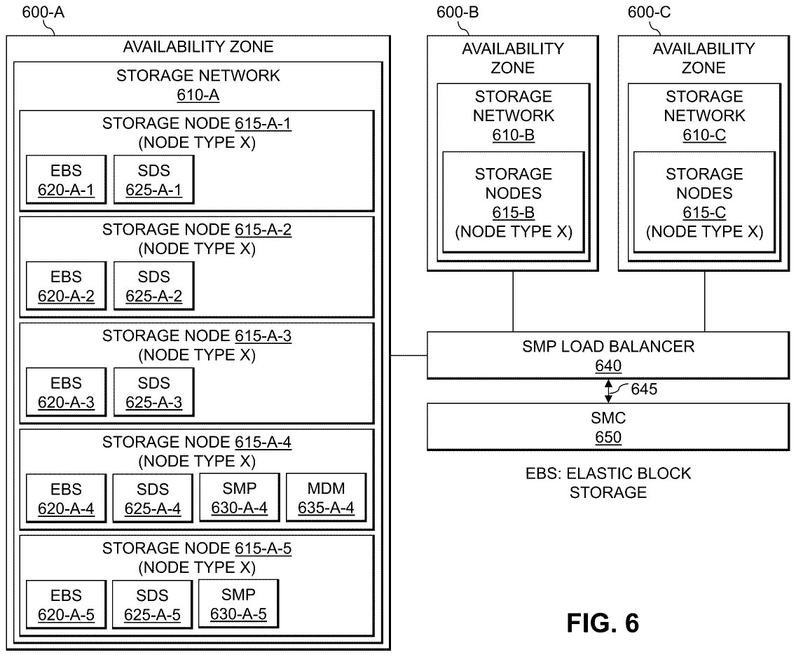

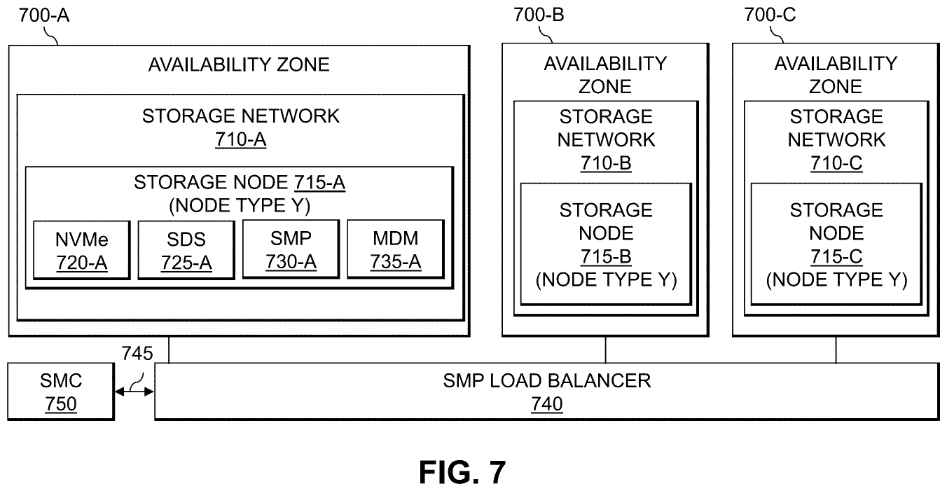

The infrastructure tuning process 500 also relocates the MDM cluster (comprised of MDM instances) to the new node type instances and replaces the old MDM instances with the new MDM instances one-by-one, as discussed further below in conjunction with FIGS. 6 and 7. Once all of the data is relocated from the old node type instances being replaced to the new node type instances, and no MDM is running on an old node type instances being replaced, the infrastructure tuning engine 370 can send one or more CSP command to remove all the instances of the old node type being replaced.

In some embodiments, the storage system 350 has functionality to “replace” nodes (e.g., adding new nodes and removing old nodes together as a single rebalance operation). In other embodiments, the infrastructure tuning engine 370 can add new nodes, perform a rebalancing on all new-and-old-nodes; and only then remove the old nodes by perform a second rebalancing.

FIG. 6 illustrates a storage system deployment having multiple availability zones prior to a configuration update by the cloud configuration platform of FIG. 3 in an illustrative embodiment. In the example of FIG. 6, a plurality of availability zones 600-A, 600-B and 600-C (collectively, availability zones 600, e.g., within a given region of a public cloud vendor) comprise respective storage networks 610-A, 610-B and 610-C (collectively, storage networks 610). The application networks and associated computing resources of the availability zones 600 have been omitted for ease of illustration. In

The storage network 610-A includes storage nodes 615-A-1 through 615-A-5 (collectively, storage nodes 615-A), each implemented using a node type X. Each storage node 615-A-1 through 615-A-5 executes a respective SDS 625-A-1 through 625-A-5 having an associated EBS 620-A-1 through 620-A-5. Storage nodes 615-A-4 and 615-A-5 also execute an SMP 630-A-4 and 630-A-5, and storage node 615-A-4 further executes an MDM 635-A-4, which operate in a similar manner as discussed above in conjunction with FIG. 2. The SMPs 630-A-4 and 630-A-5 on storage nodes 615-A-4 and 615-A-5 provide functionality for load balancing among the storage nodes 615-A through communications with an SMP load balancer 640. The SMP load balancer 640 provides storage metrics to an SMC 650 (e.g., SMC 340), via a connection 645, as discussed herein.

The availability zones 600-B and 600-C and storage networks 610-B and 610-C may be implemented in a similar manner as the availability zone 600-A and the storage network 610-A, respectively. For example, the storage networks 610-B and 610-C each comprise five storage nodes 615-B, 615-C, respectively, implemented using a node type X, in a similar manner as the five storage nodes 615-A of storage network 610-A. In some embodiments, an MDM on one of the storage networks 610 may serve as a tiebreaker MDM, in a known manner.

In the example of FIG. 6, the storage system comprises 15 instances of storage nodes 615-A implemented using node type X with associated EBS. The infrastructure recommendation engine 320 will monitor storage array usage metrics obtained from the storage system and infrastructure node utilization metrics obtained from the CSP, for example. The infrastructure recommendation engine 320 will evaluate potential configurations, associated infrastructure operating costs and associated migration costs, as well as new infrastructure node types that become available (e.g., post-deployment) and will recommend an update to a given potential configuration that satisfies one or more designated criteria.

FIG. 7 illustrates the storage system deployment of FIG. 6 following a configuration update by the cloud configuration platform of FIG. 3 in an illustrative embodiment. In the example of FIG. 7, the 15 instances of storage nodes 615-A implemented using node type X are replaced with three storage nodes 715-A, 715-B, 715-C implemented using node type Y having attached ephemeral storage (e.g., NVMe storage).

As noted above, when the storage system is configured as shown in FIG. 6, the infrastructure recommendation engine 320 will continue to evaluate potential configurations, associated infrastructure operating costs and associated migration costs, as well as new infrastructure node types that become available (e.g., post-deployment) and will recommend an update to a given potential configuration that satisfies one or more designated criteria. The infrastructure recommendation engine 320 may observe, for example, low storage capacity utilization (e.g., below a configured capacity utilization threshold of 50) and a large number of I/O operations, and may recommend a high-performance instance. In the example of FIG. 7, the infrastructure recommendation engine 320 polls the CSP and determines that a new high performance node type Y has become available, that would allow a fewer number of instances to support the storage system, at a lower overall cost.

The storage system of FIG. 7 is implemented across a plurality of availability zones 700-A, 700-B and 700-C (collectively, availability zones 700, e.g., within a given region of a public cloud vendor) comprising respective storage networks 710-A, 710-B and 710-C (collectively, storage networks 710). The application networks and associated computing resources of the availability zones 700 have been omitted for ease of illustration.

The storage network 710-A includes a storage node 715-A implemented using a node type Y. Storage node 715-A executes a respective SDS 725-A, having an associated ephemeral storage 720-A (e.g., NVMe storage), an SMP 730-A and an MDM 735-A, which operate in a similar manner as discussed above in conjunction with FIG. 2. The SMP 730-A on storage node 715-A provides functionality for load balancing among the storage nodes through communications with an SMP load balancer 740. The SMP load balancer 740 provides storage metrics to an SMC 750 (e.g., SMC 340), via a connection 745, as discussed herein.

The availability zones 700-B and 700-C and storage networks 710-B and 710-C may be implemented in a similar manner as the availability zone 700-A and the storage network 710-A, respectively. For example, the storage networks 610-B and 600-C each comprise one high performing storage node 715-B, 715-C, respectively, implemented using a node type Y, in a similar manner as the one storage node 715-A of storage network 710-A. In some embodiments, an MDM on one of the storage networks 710 may serve as a tiebreaker MDM, in a known manner.

In other examples, the storage system may have been initially deployed using instances of node type X 625-A, as in the example of FIG. 6, and in response to heavy I/O utilization, the cloud configuration platform 300 can add additional instances of node type X 625-A or replace node type X 625-A with newer instance types (such as the node type Y of FIG. 7), for which a smaller number of instances can satisfy the storage system metrics and the infrastructure node utilization metrics, as in the example of FIG. 7. In a further variation, each of the instances of node type X 625-A may have had ten associated storage drives with 500 GB of storage per instance. The cloud configuration platform 300 can observe that the storage capacity is underutilized and may recommend removing five of the 500 GB storage drives per node type X instance, bringing the costs down.

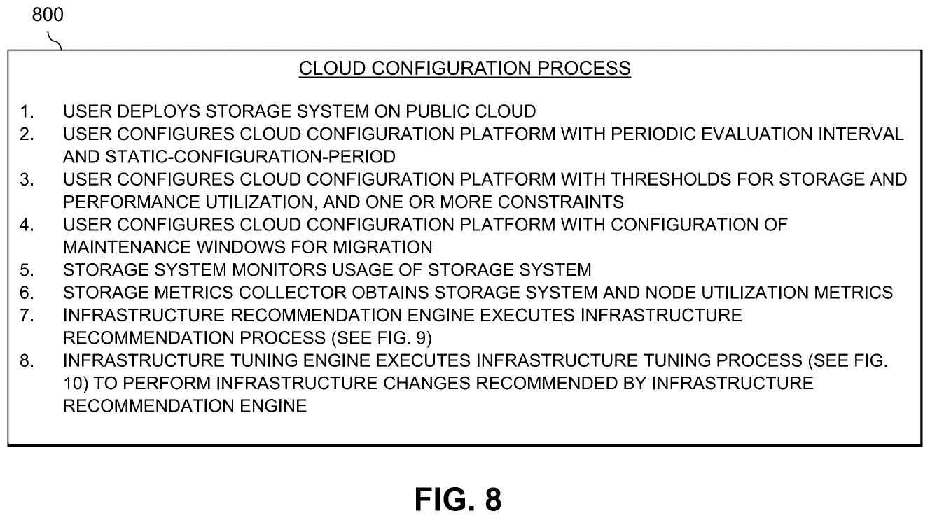

FIG. 8 illustrates exemplary pseudocode for a cloud configuration process 800 in accordance with an illustrative embodiment. In the example of FIG. 8, a user deploys a storage system (e.g., a software-defined-storage system) on the public cloud and configures the cloud configuration platform 300 with a periodic evaluation interval and a static-configuration-period.

The user configures the cloud configuration platform 300 with one or more thresholds for storage and performance utilization, and one or more constraints. For example, the user may specify the following thresholds and constraints: a lowest allowed resiliency per storage group (e.g., which will not use ephemeral storage); a cross-availability zone resiliency required per storage group (e.g., will always deploy across availability zones); a minimum and maximum used capacity per node; a minimum and maximum CPU utilization per node; and a minimum and maximum network throughput utilization per node.

The user also configures the cloud configuration platform 300 with a configuration of maintenance windows for migration. The storage system monitors the usage of storage system (e.g., an amount, frequency, and size of read and write I/Os; a throughput; a latency; and a capacity consumption).

The storage metrics collector 340 obtains storage system metrics and node utilization metrics (e.g., capacity, bandwidth and CPU utilizations). The infrastructure recommendation engine 320 executes the infrastructure recommendation process, as discussed further below in conjunction with FIG. 9. The infrastructure tuning engine 370 executes the infrastructure tuning process, as discussed further below in conjunction with FIG. 10, to perform infrastructure changes recommended by the infrastructure recommendation engine 320.

FIG. 9 illustrates exemplary pseudocode for an infrastructure recommendation process 900 in accordance with an illustrative embodiment. In the example of FIG. 9, the infrastructure recommendation process 900 initially obtains metrics for, for example, I/O operations, provisioned capacity and node utilization. The infrastructure recommendation process 900 then compares the obtained metrics against one or more infrastructure constraints.

In addition, the storage requirements are compared against the available cloud infrastructure options in order to generate one or more infrastructure recommendations (such as an infrastructure recommendation of no change, change instance family, change instance type (e.g., within the same instance family), increase or decrease instance type attributes, change drive size, remove drives and/or add drives).

FIG. 10 illustrates exemplary pseudocode for an infrastructure tuning process 1000 in accordance with an illustrative embodiment. In the example of FIG. 10, the infrastructure tuning process 1000 initially instantiates one or more recommended node types by deploying the recommended instance family and instance type, with a number of storage drives of recommended type and size, using the CSP APIs 330. One or more new node types are added to the storage system using the storage system API.

A removal of the old node types from the storage system is then initiated. The infrastructure tuning process 1000 waits for a designated time for the storage system to stabilize (e.g., after a rebalancing) and then removes one or more old node types from the storage system using the storage system API. The storage system is now deployed on the recommended infrastructure, with the associated cost savings, performance and storage utilization within the predefined thresholds.

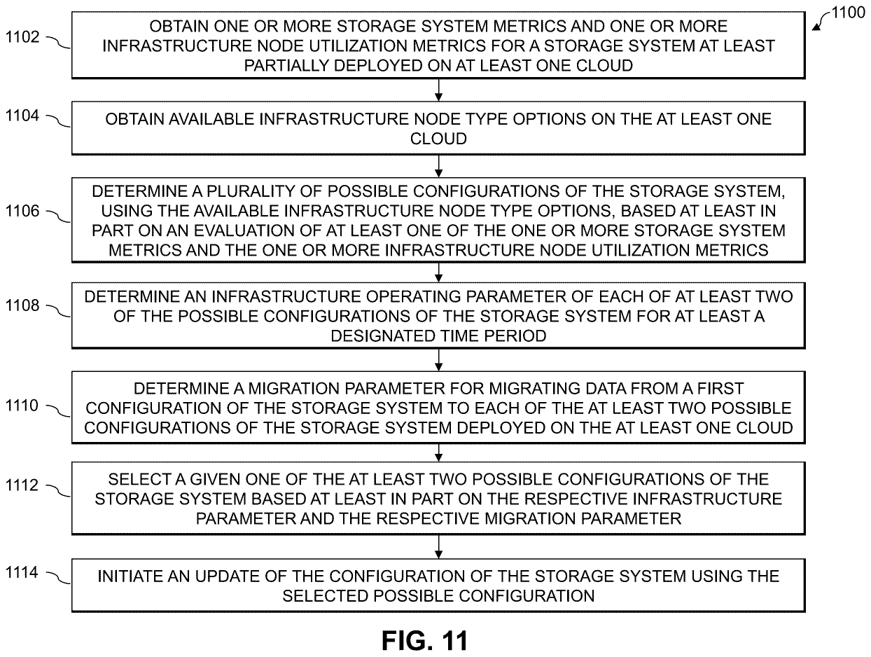

FIG. 11 is a flow diagram illustrating an exemplary implementation of a method 1100 for updating configurations of deployed cloud-based storage systems in accordance with an illustrative embodiment. In the example of FIG. 11, one or more storage system metrics and one or more infrastructure node utilization metrics are obtained in step 1102 for a storage system at least partially deployed on at least one cloud.

Available infrastructure node type options on the at least one cloud are obtained in step 1104. A plurality of possible configurations of the storage system is determined during step 1106, using the available infrastructure node type options, based at least in part on an evaluation of at least one of the one or more storage system metrics and the one or more infrastructure node utilization metrics.

An infrastructure operating parameter (e.g., cost) of each of at least two of the possible configurations of the storage system is determined in step 1108 for at least a designated time period. A migration parameter (e.g., cost) for migrating data from a first configuration of the storage system to each of the at least two possible configurations of the storage system is determined in step 1110.

A given one of the at least two possible configurations of the storage system is selected in step 1112 based at least in part on the respective infrastructure parameter and the respective migration parameter. An update of the configuration of the storage system is initiated in step 1114 using the selected possible configuration.

In some embodiments, the first configuration of the storage system comprises a current configuration. At least one of the plurality of possible configurations of the storage system may comprise an infrastructure node type that was not available at a time of an initial deployment of the storage system.

In one or more embodiments, a configuration of the storage system may be maintained for a minimum designated configuration period unless the storage system does not satisfy one or more of (i) one or more designated performance requirements and (ii) one or more designated utilization requirements. The determining the plurality of possible configurations of the storage system may be performed in response to an occurrence of an event (e.g., a designated trigger, such as an introduction of one or more new node types or a failure of the storage system to meet one or more expected performance constraints or a time-based event) following an expiration of the minimum designated configuration period.

In at least one embodiment, the selected possible configuration comprises at least one new node type, relative to the first configuration of the storage system, and wherein the initiating the update of the configuration of the storage system may comprise instantiating a recommended number of instances of the new node type; deploying storage system binary components on the new node type instances; sending one or more metadata management commands to add the new node type instances; relocating at least one metadata management cluster to one or more instances of the new node type; replacing one or more metadata management instances being replaced with one or more new metadata management instances; relocating data from the node type instances being replaced to the new node type instances; and removing the node type instances being replaced in response to the data being relocated from the node type instances being replaced and no metadata manager executing on the node type instances being replaced. The one or more storage system metrics may comprise one or more of input/output operation metrics and metrics related to a provisioned capacity of the storage system.

The particular processing operations and other network functionality described in conjunction with the diagrams of FIGS. 4, 5 and 8 through 11 are presented by way of illustrative example only and should not be construed as limiting the scope of the disclosure in any way. Alternative embodiments can use other types of processing operations for updating configurations of deployed cloud-based storage systems. For example, the ordering of the process steps may be varied in other embodiments, or certain steps may be performed concurrently with one another rather than serially. In one aspect, the process can skip one or more of the steps. In other aspects, one or more of the steps are performed simultaneously. The processing of one or more of the steps can also be distributed between multiple components. In some aspects, additional steps can be performed.

In some embodiments, techniques are provided for updating configurations of deployed cloud-based storage systems. In at least some embodiments, latency associated with processing resource requests is improved by sending a response (such as an acknowledgement) to a user device, in response to a data portion associated with a given resource request being stored in a persistent cache (or another persistent storage device). In at least one embodiment, once the response is sent to the user device, one or more additional resource requests may be sent by the user device, to improve latency, while one or more designated post-response tasks associated with the given resource request may be performed by (or on behalf of) the resource.

One or more embodiments of the disclosure provide improved methods, apparatus and computer program products for updating configurations of deployed cloud-based storage systems. The foregoing applications and associated embodiments should be considered as illustrative only, and numerous other embodiments can be configured using the techniques disclosed herein, in a wide variety of different applications.

It should also be understood that the disclosed cloud-based storage system configuration techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for updating configurations of deployed cloud-based storage systems may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based storage system configuration engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based storage system configuration platform in illustrative embodiments. The cloud-based systems can include block storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

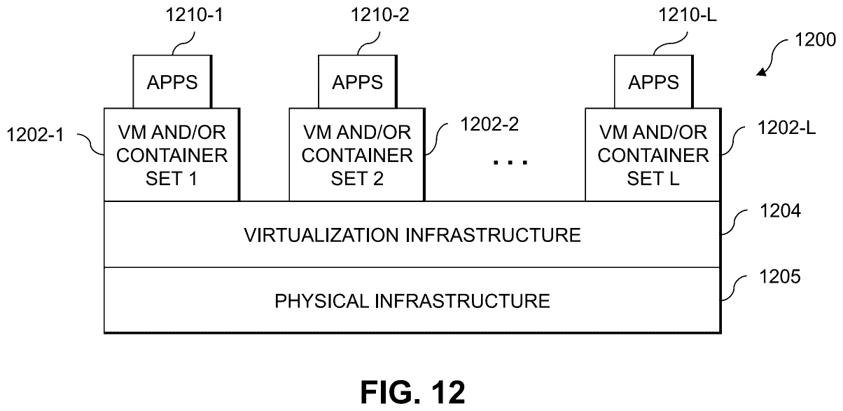

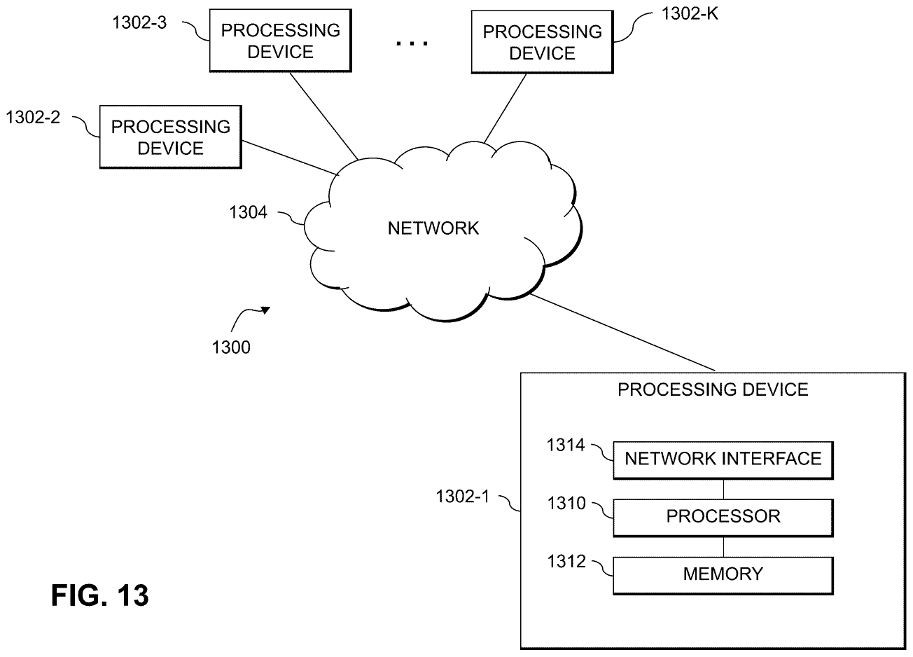

Illustrative embodiments of processing platforms will now be described in greater detail with reference to FIGS. 12 and 13. These platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of an information processing system. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. Such implementations can provide cloud-based storage system configuration functionality of the type described above for one or more processes running on a given one of the VMs. For example, each of the VMs can implement cloud-based storage system configuration control logic and associated functionality for determining costs for migrating data from a current storage system configuration to one or more possible alternate storage system configurations.

An example of a hypervisor platform that may be used to implement a hypervisor within the virtualization infrastructure 1204 is a compute virtualization platform which may have an associated virtual infrastructure management system such as server management software. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system. Such implementations can provide cloud-based storage system configuration functionality of the type described above for one or more processes running on different ones of the containers. For example, a container host device supporting multiple containers of one or more container sets can implement one or more instances of cloud-based storage system configuration control logic and associated functionality for determining costs for migrating data from a current storage system configuration to one or more possible alternate storage system configurations.

As is apparent from the above, one or more of the processing modules or other components of the information processing system may each run on a computer, server, storage device or other processing platform element. A given such element may be viewed as an example of what is more generally referred to herein as a processing device. The cloud infrastructure 1200 shown in FIG. 12 may represent at least a portion of one processing platform. Another example of such a processing platform is processing platform 1300 shown in FIG. 13.

The processing platform 1300 in this embodiment comprises at least a portion of the given system and includes a plurality of processing devices, denoted 1302-1, 1302-2, 1302-3, . . . 1302-K, which communicate with one another over a network 1304. The network 1304 may comprise any type of network, such as a WAN, a LAN, a satellite network, a telephone or cable network, a cellular network, a wireless network such as WiFi or WiMAX, or various portions or combinations of these and other types of networks.

The processing device 1302-1 in the processing platform 1300 comprises a processor 1310 coupled to a memory 1312. The processor 1310 may comprise a microprocessor, a microcontroller, an application specific integrated circuit (ASIC), a field programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements, and the memory 1312, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 12 or 13, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining one or more storage system metrics and one or more infrastructure node utilization metrics for a storage system at least partially deployed on at least one cloud;
obtaining available infrastructure node type options on the at least one cloud;
determining a plurality of possible configurations of the storage system, using the available infrastructure node type options, based at least in part on an evaluation of at least one of the one or more storage system metrics and the one or more infrastructure node utilization metrics;
determining an infrastructure operating parameter of each of at least two of the possible configurations of the storage system for at least a designated time period;
determining a migration parameter for migrating data from a first configuration of the storage system to each of the at least two possible configurations of the storage system;
selecting a given one of the at least two possible configurations of the storage system based at least in part on the respective infrastructure parameter and the respective migration parameter; and
initiating an update of the configuration of the storage system using the selected possible configuration;
wherein the method is performed by at least one processing device comprising a processor coupled to a memory.

2. The method of claim 1, wherein the first configuration of the storage system comprises a current configuration.

3. The method of claim 1, wherein at least one of the plurality of possible configurations of the storage system comprises an infrastructure node type that was not available at a time of an initial deployment of the storage system.

4. The method of claim 1, wherein a configuration of the storage system is maintained for a minimum designated configuration period unless the storage system does not satisfy one or more of (i) one or more designated performance requirements and (ii) one or more designated utilization requirements.

5. The method of claim 4, wherein the determining the plurality of possible configurations of the storage system is performed in response to an occurrence of an event following an expiration of the minimum designated configuration period.

6. The method of claim 1, wherein the selected possible configuration comprises at least one new node type, relative to the first configuration of the storage system, and wherein the initiating the update of the configuration of the storage system comprises instantiating a recommended number of instances of the new node type; deploying storage system binary components on the new node type instances; sending one or more metadata management commands to add the new node type instances; relocating at least one metadata management cluster to one or more instances of the new node type; replacing one or more metadata management instances being replaced with one or more new metadata management instances; relocating data from the node type instances being replaced to the new node type instances; and removing the node type instances being replaced in response to the data being relocated from the node type instances being replaced and no metadata manager executing on the node type instances being replaced.

7. The method of claim 1, wherein the one or more storage system metrics comprise one or more of input/output operation metrics and metrics related to a provisioned capacity of the storage system.

8. An apparatus comprising:
at least one processing device comprising a processor coupled to a memory;
the at least one processing device being configured to implement the following steps:
obtaining one or more storage system metrics and one or more infrastructure node utilization metrics for a storage system at least partially deployed on at least one cloud;
obtaining available infrastructure node type options on the at least one cloud;
determining a plurality of possible configurations of the storage system, using the available infrastructure node type options, based at least in part on an evaluation of at least one of the one or more storage system metrics and the one or more infrastructure node utilization metrics;
determining an infrastructure operating parameter of each of at least two of the possible configurations of the storage system for at least a designated time period;
determining a migration parameter for migrating data from a first configuration of the storage system to each of the at least two possible configurations of the storage system;
selecting a given one of the at least two possible configurations of the storage system based at least in part on the respective infrastructure parameter and the respective migration parameter; and
initiating an update of the configuration of the storage system using the selected possible configuration.

9. The apparatus of claim 8, wherein the first configuration of the storage system comprises a current configuration.

10. The apparatus of claim 8, wherein at least one of the plurality of possible configurations of the storage system comprises an infrastructure node type that was not available at a time of an initial deployment of the storage system.

11. The apparatus of claim 8, wherein a configuration of the storage system is maintained for a minimum designated configuration period unless the storage system does not satisfy one or more of (i) one or more designated performance requirements and (ii) one or more designated utilization requirements.

12. The apparatus of claim 11, wherein the determining the plurality of possible configurations of the storage system is performed in response to an occurrence of an event following an expiration of the minimum designated configuration period.

13. The apparatus of claim 8, wherein the selected possible configuration comprises at least one new node type, relative to the first configuration of the storage system, and wherein the initiating the update of the configuration of the storage system comprises instantiating a recommended number of instances of the new node type; deploying storage system binary components on the new node type instances; sending one or more metadata management commands to add the new node type instances; relocating at least one metadata management cluster to one or more instances of the new node type; replacing one or more metadata management instances being replaced with one or more new metadata management instances; relocating data from the node type instances being replaced to the new node type instances; and removing the node type instances being replaced in response to the data being relocated from the node type instances being replaced and no metadata manager executing on the node type instances being replaced.

14. The apparatus of claim 8, wherein the one or more storage system metrics comprise one or more of input/output operation metrics and metrics related to a provisioned capacity of the storage system.

15. A non-transitory processor-readable storage medium having stored therein program code of one or more software programs, wherein the program code when executed by at least one processing device causes the at least one processing device to perform the following steps:
obtaining one or more storage system metrics and one or more infrastructure node utilization metrics for a storage system at least partially deployed on at least one cloud;
obtaining available infrastructure node type options on the at least one cloud;
determining a plurality of possible configurations of the storage system, using the available infrastructure node type options, based at least in part on an evaluation of at least one of the one or more storage system metrics and the one or more infrastructure node utilization metrics;
determining an infrastructure operating parameter of each of at least two of the possible configurations of the storage system for at least a designated time period;
determining a migration parameter for migrating data from a first configuration of the storage system to each of the at least two possible configurations of the storage system;
selecting a given one of the at least two possible configurations of the storage system based at least in part on the respective infrastructure parameter and the respective migration parameter; and
initiating an update of the configuration of the storage system using the selected possible configuration.

16. The non-transitory processor-readable storage medium of claim 15, wherein at least one of the plurality of possible configurations of the storage system comprises an infrastructure node type that was not available at a time of an initial deployment of the storage system.

17. The non-transitory processor-readable storage medium of claim 15, wherein a configuration of the storage system is maintained for a minimum designated configuration period unless the storage system does not satisfy one or more of (i) one or more designated performance requirements and (ii) one or more designated utilization requirements.

18. The non-transitory processor-readable storage medium of claim 17, wherein the determining the plurality of possible configurations of the storage system is performed in response to an occurrence of an event following an expiration of the minimum designated configuration period.

19. The non-transitory processor-readable storage medium of claim 15, wherein the selected possible configuration comprises at least one new node type, relative to the first configuration of the storage system, and wherein the initiating the update of the configuration of the storage system comprises instantiating a recommended number of instances of the new node type; deploying storage system binary components on the new node type instances; sending one or more metadata management commands to add the new node type instances; relocating at least one metadata management cluster to one or more instances of the new node type; replacing one or more metadata management instances being replaced with one or more new metadata management instances; relocating data from the node type instances being replaced to the new node type instances; and removing the node type instances being replaced in response to the data being relocated from the node type instances being replaced and no metadata manager executing on the node type instances being replaced.

20. The non-transitory processor-readable storage medium of claim 15, wherein the one or more storage system metrics comprise one or more of input/output operation metrics and metrics related to a provisioned capacity of the storage system.
